(19) United States
(12) Patent Application Publication
(10) Pub. No.: US 2024/0187705 A1
(43) Pub. Date: Jun. 6, 2024

(54) SERVER AND COMPUTER PROGRAM

(71) Applicant: 17LIVE Japan Inc., Tokyo (JP)

(72) Inventors: Chun-Sheng HSU, Taipei City (TW); Chia-Han CHANG, Taipei City (TW)

(21) Appl. No.: 18/351,196

(22) Filed: Jul. 12, 2023

(30) Foreign Application Priority Data
Dec. 2, 2022 (JP) 2022-193518

(51) Int. Cl. H04N 21/6547; H04N 21/2187; H04N 21/24

(52) U.S. Cl. CPC H04N 21/6547; H04N 21/2187; H04N 21/24

(57) ABSTRACT

A server for handling violation in a live streaming platform, comprising: transmitting a first information of a first violation of a first user to a first user terminal of the first user, wherein the first information includes information of setting the status of the first user terminal from first status to second status; in response to a first operation on the first information from the first user terminal, setting the status of the first user terminal from first status to third status; wherein the functions in the second status are more limited than the functions in the third status. The present disclosure may help the server with managing the status of each user in an easier and more efficient way and the user experience may also be enhanced.

### CROSS-REFERENCE TO RELATED APPLICATIONS

This application is based on and claims the benefit of priority from Japanese Patent Application Serial No. 2022-193518 (filed on Dec. 2, 2022), the contents of which are hereby incorporated by reference in its entirety.

### TECHNICAL FIELD

This disclosure relates to information and communication technology, and in particular, to a server, method and computer program in a live streaming.

### BACKGROUND

Some APPs or platforms provide live streaming service for streamers and viewers to interact with each other. The streamers may have a performance to cheer up the viewers and the viewers may send gifts to support the streamers. In other words, the platform may be like a virtual world.

Although the users are in the virtual world, their behavior should follow the rules in the platform. If some users violate the rules, the platform provider may ban or freeze the user account as a punishment. The reason for violation may be contrary to public order, morality or the like. Patent Document 1 disclose a method of banning an user account if the content issued by the user account does not meet the rules.
[Patent Document 1]: CN111797352A

However, some users do not understand the rules well and would violate the rules by accident. In this situation, if the platform provider bans the user, the user may feel innocent and does not know the reason. In the worst situation, the user may feel irritated and lead to poor user experience. Therefore, how to improve the user experience is very important.

### SUMMARY

An embodiment of subject application relates to a server for handling violation in a live streaming platform, comprising: transmitting a first information of a first violation of a first user to a first user terminal of the first user, wherein the first information includes information of setting the status of the first user terminal from first status to second status; in response to a first operation on the first information from the first user terminal, setting the status of the first user terminal from first status to third status; wherein the functions in the second status are more limited than the functions in the third status.

Another embodiment of subject application relates to a method a server for handling violation in a live streaming platform, comprising: transmitting a first information of a first violation of a first user to a first user terminal of the first user, wherein the first information includes information of adding a first ticket on the first user of the first user terminal; monitoring a status of the ticket of the first user, and setting the status of the first user terminal to second status if the status of the ticket reaches a threshold.

Another embodiment of subject application relates to a computer program for causing a terminal to realize the functions of: transmitting a first information of a first violation of a first user to a first user terminal of the first user, wherein the first information includes information of setting the status of the first user terminal from first status to second status; in response to a first operation on the first information from the first user terminal, setting the status of the first user terminal from first status to third status; wherein the functions in the second status are more limited than the functions in the third status.

The present disclosure may help the server with managing the status of each user in an easier and more efficient way. Moreover, the user may check and select their status in a quicker and more convenient manner. The server may provide a variety of alternatives for the users when violations are detected. Therefore, the user experience may be enhanced.

### BRIEF DESCRIPTION OF THE DRAWINGS

FIG. 1 is a schematic configuration of a live streaming system 1 according to some embodiments of subject application;

FIG. 2 is a schematic block diagram of the user terminal 20 according to some embodiments of subject application:

FIG. 3 is a schematic block diagram of the server 10 according to some embodiments of subject application;

FIG. 4 shows an exemplary data structure of the stream DB 320 of FIG. 3;

FIG. 5 shows an exemplary data structure of the user DB 322 of FIG. 3:

FIG. 6 shows an exemplary data structure of the violation DB 324 of FIG. 3;

FIG. 7 shows an exemplary data structure of the ticket DB 326 of FIG. 3;

FIG. 8 shows an exemplary data structure of the probation DB 328 of FIG. 3;

FIG. 9 shows an exemplary data structure of the violation look-up table 330 of FIG. 3;

FIG. 10 shows an exemplary data structure of the probation look-up table 332 of FIG. 3;

FIG. 11-FIG. 19 are exemplary screen images of a live-streaming room screen 610 shown on the display of the streamer user terminal 20 or the viewer user terminal 30;

FIG. 20-FIG. 22 are flowcharts illustrating an operation of the configuration of the live streaming system 1 according to some embodiments of subject application;

FIG. 23 is a schematic block diagram of the status mechanism in the live streaming system 1 according to some embodiments of subject application;

FIG. 24 is an exemplary sequence chart illustrating an operation of the configuration of the live streaming system 1 according to some embodiments of subject application.

FIG. 25 is an exemplary hardware configuration of the information processing device according to some embodiments of subject application.

### DETAILED DESCRIPTION

Hereinafter, the identical or similar components, members, procedures or signals shown in each drawing are referred to with like numerals in all the drawings, and thereby an overlapping description is appropriately omitted. Additionally, a portion of a member which is not important in the explanation of each drawing is omitted.

The live streaming system 1 according to some embodiments of subject application provides enhancement among the users to communicate and interact smoothly. More specifically, it entertains the viewers and streamers in a technical way.

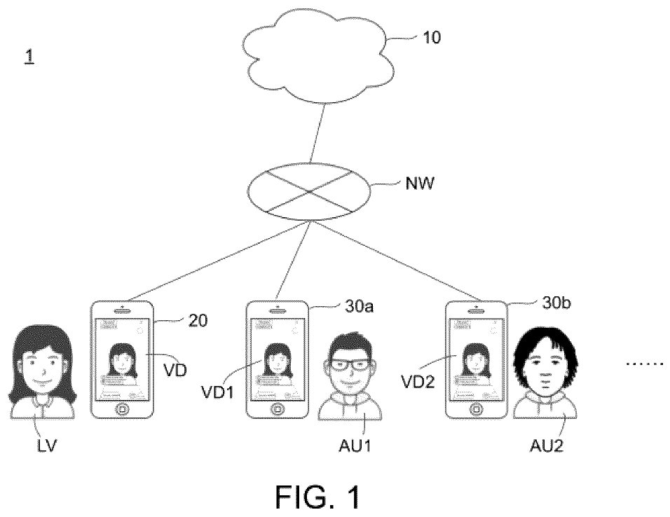

FIG. 1 shows a schematic configuration of a live streaming system 1 according to some embodiments of subject application. The live streaming system 1 provides a live streaming service for the streaming streamer (may also be referred as live or streamer) LV and viewer (may also be referred as audience) AU (AU1, AU2 . . . ) to interact mutually in real time. As shown in FIG. 1, the live streaming system 1 may include a server 10, a user terminal 20 and a user terminal 30 (30a, 30b . . . ). The user terminal 20 may be a streamer and the user terminal 30 may be a viewer. In some embodiments, the streamers and viewers may be referred to as the user. The server 10 may include one or a plurality of information processing devices connected via network NW. The user terminal 20 and 30 may be, for example, a portable terminal such as the smartphone, tablet, laptop PC, recorder, mobile game console, wearable device or the like, or the stationary computer such as desktop PC. The server 10, user terminal 20 and user terminal 30 may be communicably connected by any type of wire or wireless network NW.

The live streaming system 1 is involved in the streamer LV, the viewer AU, and APP provider (not shown), who provides the server 10. The streamer LV may record his/her own contents such as songs, talks, performance, game streaming or the like by his/her own user terminal 20 and upload to the server 10 and be the one who distributes contents in real time. In some embodiments, the streamer LV may interact with the viewer AU via the live streaming.

The APP provider may provide a platform for the contents to go on live streaming in the server 10. In some embodiments, the APP provider may be the media or manager to manage the real time communication between the streamer LV and viewer AU. The viewer AU may access the platform by the user terminal 30 to select and watch the contents he/she would like to watch. The viewer AU may perform operations to interact with the streamer, such as commenting or cheering the streamer, by the user terminal 30. The streamer, who provides the contents, may respond to the comment or cheer. The response of the streamer may be transmitted to the viewer AU by video and/or audio or the like. Therefore, a mutual communication among the streamer and viewer may be accomplished.

The “live streaming” in this specification may be referred to as the data transmission which enables the contents the streamer LV recorded by the user terminal 20 to be substantially reproduced and watched by the viewer AU via the user terminal 30, In some embodiments, the “live streaming” may also refer to the streaming which is accomplished by the above data transmission. The live streaming may be accomplished by the well-known live streaming technology such as HTTP Live Streaming, Common Media Application Format, Web Real-Time Communications, Real-Time Messaging Protocol, MPEG DASH or the like. The live streaming may further include the embodiment that the viewer AU may reproduce or watch the contents with specific delay while the streamer is recording the contents. Regarding the magnitude of the delay, it should be at least small enough to enable the streamer LV and the viewer AU to communicate. However, live streaming is different from so-called on-demand streaming. More specifically, the on-demand streaming may be referred to as storing all data, which records the contents, in the server and then providing the data from the server to the user at random timing according to the user's request.

The “streaming data” in this specification may be referred to as the data includes image data or voice data. More specifically, the image data (may be referred to as video data) may be generated by the image pickup feature of the user terminal 20 and 30. The voice data (may be referred to as audio data) may be generated by the audio input feature of the user terminal 20 and 30. The streaming data may be reproduced by the user terminal 20 30, so that the contents relating to users may be available for watching. In some embodiments, during the period from the streaming data being generated by the user terminal of the streamer to being reproduced by the user terminal of the viewer, the processing of changing format, size or specification of the data, such as compression, extension, encoding, decoding, transcoding or the like, is predictable. Before and after this kind of processing, the contents (such as video and audio) are substantially unchanged, so it is described in the current embodiments of the present disclosure that the streaming data before being processed is the same as that after being processed. In other words, if the streaming data is generated by the user terminal of the streamer and reproduced by the user terminal of the viewer via the server 10, the streaming data generated by the user terminal of the streamer, the streaming data passed through the server 10 and the streaming data received and reproduced by the by the user terminal of the viewer are all the same streaming data.

As shown in FIG. 1, the streamer LV is providing the live streaming. The user terminal 20 of the streamer generates the streaming data by recording his/her video and/or audio, and transmits to the server 10 via the network NW. At the same time, the user terminal 20 may display the video VD on the display of the user terminal 20 to check the streaming contents of the streamer LV.

The viewer AU1, AU2 of the user terminal 30a, 30b, who request the platform to provide the live streaming of the streamer, may receive streaming data corresponding to the live streaming via the network NW and reproduce the received streaming data to display the video VD1, VD2 on the display and output the audio from a speaker or the like. The video VD1, VD2 displayed on the user terminal 30a, 30b respectively may be substantially the same as the video VD recorded by the user terminal of the streamer LV, and the audio outputted from the terminal 30a, 30b may also be substantially the same as the audio recorded by the user terminal of the streamer LV.

The recording at the user terminal 20 of the streamer may be simultaneous with the reproducing of the streaming data at the user terminal 30a, 30b of the viewer AU1, AU2. If a viewer AU1 inputs a comment on the contents of the streamer LV into the user terminal 30a, the server 10 will display the comment on the user terminal 20 of the streamer in real time, and also display on the user terminal 30a, 30b of the viewer AU1, AU2 respectively. If the streamer LV responds to the comment, the response may be outputted as the text, image, video or audio from the terminal 30a, 30b of the viewer AU1, AU2, so that the communication of the streamer LV and viewer LV may be realized. Therefore, the live streaming system may realize the live streaming of two-way communication.

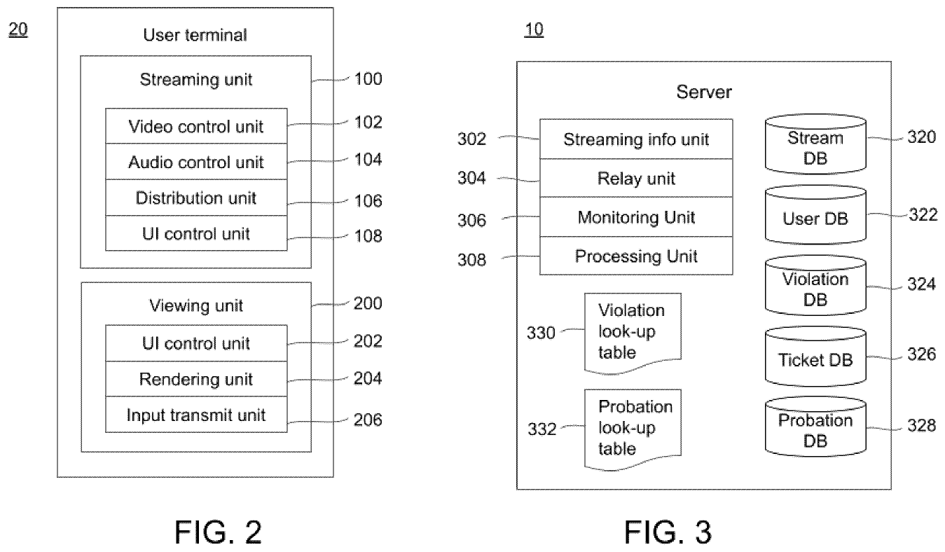

FIG. 2 is a block diagram showing a function and configuration of the user terminal 20 in FIG. 1 according to the embodiment of the present disclosure. The user terminal 30 has the similar function and configuration of the user terminal 20. The blocks depicted in the block diagram of this specification are implemented in hardware such as devices like a CPU of a computer or mechanical components, and in software such as a computer program depicts functional blocks implemented by the cooperation of these elements. Therefore, it will be understood by those skilled in the art that the functional blocks may be implemented in a variety of manners by a combination of hardware and software.

The streamer LV and viewer AU may download and install the live streaming application (live streaming APP) of the present disclosure to the user terminal 20 and 30 from the download site via network NW. Or the live streaming APP may be pre-installed in the user terminal 20 and 30. By the execution of the live streaming by the user terminal 20 and 30, the user terminals 20 and 30 may communicate with the server 10 via the network NW to realize a plurality of functions. The functions realized by the execution of the live streaming APP by the user terminal 20 and 30 (More specifically, the processor such as CPU) is described below as the functions of the user terminal 20 and 30. These functions are basically the functions that the live streaming APP makes the user terminals 20 and 30 realize. In some embodiments, these functions may also be realized by transmitting from the server 10 to the web browser of the user terminal 20 and 30 via network NW and be executed by the computer program of the web browser. The computer program may be written in the programming language such as HTML (Hyper Text Markup Language) or the like.

The user terminal 20 includes streaming unit 100 and viewing unit 200. In some embodiments, the streaming unit 100 is configured to record the audio and/or video data of the user and generate streaming data to transmit to the server 10. The viewing unit 200 is configured to receive and reproduce streaming data from server 10. In some embodiments, a user may activate the streaming unit 100 when broadcasting or activate the viewing unit 200 when watching streaming respectively. In some embodiments, the user terminal who is activating the streaming unit 100 may be referred to as an streamer or be referred to as the user terminal which generates the streaming data. The user terminal who is activating the viewing unit 200 may be referred to as an viewer or be referred to as the user terminal which reproduces the streaming data.

The streaming unit 100 may include video control unit 102, audio control unit 104, distribution unit 106 and UI control unit 108. The video control unit 102 may be connected to a camera (not shown) and the video is controlled by the camera. The video control unit 102 may obtain the video data from the camera. The audio control unit 104 may be connected to a microphone (not shown) and the audio is controlled by the microphone. The audio control unit 104 may obtain the audio data from the microphone.

The distribution unit 106 receives streaming data, which includes video data from the video control unit 102 and audio data from the audio control unit 104, and transmits to the server 10 via network NW. In some embodiments, the distribution unit 106 transmits the streaming data in real-time. In other words, the generation of the streaming data from the video control unit 102 and audio control unit 104, and the distribution of the distribution unit 106 is performed simultaneously.

UI control unit 108 controls the UI for the streamer. The UI control unit 108 is connected to a display (not shown) and is configured to generate the streaming data to whom the distribution unit 106 transmits, reproduces and displays the streaming data on the display. The UI control unit 108 shows the object for operating or the object for instruction-receiving on the display and is configured to receive the tap input from the streamer.

The viewing unit 200 may include UI control unit 202, rendering unit 204 and input transmit unit 206. The viewing unit 200 is configured to receive streaming data from server 10 via network NW. The UI control unit 202 controls the UI for the viewer. The UI control unit 202 is connected to a display (not shown) and/or speaker (not shown) and is configured to display the video on the display and output the audio from the speaker by reproducing the streaming data. In some embodiments, Outputting the video on the display and audio from the speaker may be referred to as “reproducing the streaming data”. The UI control unit 202 may be connected to an input unit such as touch panel, keyboard or display or the like to obtain input from the users.

The rendering unit 204 may be configured to render the streaming data from the server 10 and the frame image. The frame image may include user interface objects for receiving input from the user, the comments inputted by the viewers and the data received from the server 10. The input transmit unit 206 is configured to receive the user input from the UI control unit 202 and transmit to the server 10 via the network NW.

In some embodiments, the user input may be clicking an object on the screen of the user terminal such as selecting a live stream, entering a comment, sending a gift, following or unfollowing an user, voting in an event, gaming or the like. For example, the input transmit unit 206 may generate gift information and transmit to server 10 via the internet NW if the user terminal of the viewer clicks a gift object on the screen in order to send a gift to the streamer.

FIG. 3 is a schematic block diagram of the server 10 according to some embodiments of the subject application. The server 10 may include streaming info unit 302, relay unit 304, monitoring unit 306, processing unit 308, stream DB 320, user DB 322, violation DB 324, ticket DB 326, probation DB 328, violation look-up table 330 and probation look-up table 332.

The streaming info unit 302 receives the request of live streaming from the user terminal 20 of the streamer via the network NW. Once receiving the request, the streaming info unit 302 registers the information of the live streaming on the stream DB 320. In some embodiments, the information of the live streaming may be the stream ID of the live streaming and/or the streamer ID of the streamer corresponding to the live streaming.

Once receiving the request of providing the information of the live streaming from the viewing unit 200 of the user terminal 30 from the viewer via the network NW, the streaming info unit 302 refers to the stream DB 320 and generates a list of the available live streaming.

The streaming info unit 302 then transmits the list to the user terminal 30 via the network NW. The UI control unit 202 of the user terminal 30 generates a live streaming selection screen according to the list and displays the list on the display of the user terminal 30.

Once the input transmit unit 206 of the user terminal 30 receives the selection of the live streaming from the viewer on the live streaming selection screen, it generates the streaming request including the stream ID of the selected live streaming and transmits to the server 10 via the network. The streaming info unit 302 may start to provide the live streaming, which is specified by the stream ID in the streaming request, to the user terminal 30. The streaming info unit 302 may update the stream DB 320 to add the viewer's viewer ID of the user terminal 30 to the streamer ID of the stream ID.

The relay unit 304 may relay the transmission of the live streaming from the user terminal 20 of the streamer to the user terminal 30 of the viewer in the live streaming started by the streaming info unit 302. The relay unit 304 may receive the signal, which indicates the user input from the viewer, from the input transmit unit 206 while the streaming data is reproducing. The signal indicating the user input may be the object-designated signal which indicates the designation of the object shown on the display of the user terminal 30. The object-designated signal may include the viewer ID of the viewer, the streamer ID of the streamer, who delivers the live streaming the viewer is viewing, and object ID specified by the object. If the object is a gift or the like, the object ID may be the gift ID or the like. Similarly, the relay unit 304 may receive the signal indicating the user input of the streamer, for example the object-designated signal, from the streaming unit 100 of the user terminal 20 while the streaming data is reproducing.

The monitoring unit 306 is configured to monitor the actions, behaviors or operations the user of the user terminal performs in the platform. The user may perform operations on the platform, and the operations may be transmitted from the user terminal to the server 10 to realize the operation. The monitoring unit 306 may monitor the operations from the user terminal to check if there are any violations in the platform.

In some embodiments, the operation may be any possible operations the user could perform on the platform. For example, the operation may be messaging, commenting, gifting, gaming or the like. In some embodiments, the “violation” may be referred to as the action, behavior or operation of the user which is not complying with the rules in the APP or platform (for example, the operator of live streaming platform interests or like). The rules may be determined flexibly by the APP or platform provider, and the APP or platform provider may receive the agreement from the user of the user terminal when the user registers their account or the like.

The monitoring unit 306 may monitor and detect the violations according to the violation look-up table 330. More specifically, the monitoring unit 306 may look up the violation look-up table to identify the violation and its corresponding treatment. Once a violation is detected, the monitoring unit 306 may transmit the information of the violation to the user terminal to inform the user of the violation or the like. The information may include the reason for violating the rule, the punishment due to the violation or the like.

In some embodiments, server 10 may transmit the information to the user via any possible means. For example, the server 10 may transmit the information via a pop-up message, transmit to the in-app mailbox, transmit to the user butler message, transmit to the email of the user or the like.

The reason may include, for example, which operations the user performed and which rules the user violates. The punishment may be the treatment of the user due to the violation. The treatment may be determined flexibly according to the practical need. In some embodiments, the treatment may be determined according to the severity of the violation.

If the violation is serious, for example, the streamer shows inappropriate parts of the naked body such as the breast or the viewer sells illegal points which are not provided by the platform provider, the user may be banned or frozen by the server 10. Freezing the user may be referred to as suspending the account and blocking the device of the user, and the user can no longer create accounts on the device.

If the violation is moderate, for example, the streamer partially shows the hair on the body or show sex toy in the live streaming or promoting illegal plug-in to the other user, the user may be banned. Banning the user may be referred to as suspending the account but the device is not blocked. The difference between ban and freeze may be that the banned user may still create accounts on the device. In some embodiments, the duration of freezing or banning may be a period of time or forever and may be determined flexibly by the platform provider.

If the violation is normal, for example, the streamer shows the underwear, focuses the camera on inappropriate parts of the body such as the breast or shows any inappropriate gesture, posture or the like, the streaming may be killed. Killing the streaming may be referred to as removing the streaming from the APP or platform. In some embodiments, if the streaming is killed, the streamer may or may not be allowed to start another stream. In some embodiments, the user may post inappropriate posts such as messages, comments, photos, profiles or the like, the server 10 may kill, hide or delete the posts as a punishment. In some embodiments, if the message includes inappropriate content such as dirty words, the server 10 may tag the user as a dirty user and mute the user. If the users are mute, their messages will be invisible in any stream rooms. In some embodiments, the ticket may be the ticket related to interactions between the user and other users in the live streaming platform. In some embodiments, the severity of the violation and the corresponding punishment and treatment may be determined according to the practical need.

In some embodiments, if the violation is serious or moderate, the user may be banned or frozen. In some embodiments, the user may receive a ticket if the violation is normal and not severe enough to be banned or frozen. For example, the user account may receive a ticket if the user is flooding the message zone or sending inappropriate messages during live streaming. Here, the ticket may be referred to as a warning or fine to the user. If the status of tickets the user receives reaches a specific threshold, the user may be banned or frozen. In some embodiments, the status of the ticket may be the number of tickets, the accumulated ticket points of the tickets, the expiration date of the ticket or the like. For example, if the tickets exceed a specific number such as five, the user may be banned or frozen. If the accumulated points of the tickets exceed a specific point such as 1,500 points, the user may be banned or frozen. If the user has expired tickets, the user may also be banned or frozen. In some embodiments, the relationship between the status of tickets and being banned/frozen may be determined flexibly.

In some embodiments, different tickets may limit different functions for the user of the user terminal. For example, tickets may limit the function of gifting, messaging, posting, streaming, watching stream, gaming or the like. In some embodiments, the functions may be functions related to interactions between the user and other users in the live streaming platform. In some embodiments, different tickets may limit the same functions or different functions. In some embodiments, the function to be limited by the ticket may be determined flexibly. In some embodiments, the function may be randomly assigned. In some embodiments, the function may be related to the violation. For example, if the user posts an inappropriate article and receives a ticket, the ticket may limit the posting function of the user. If the streamer said dirty words during streaming and received a ticket, the ticket may limit the streaming function of the user. According to the embodiments, it motivates users to follow the rules in the platform and the quality of the platform may be improved. Moreover, the ticket also motivates the user of the user terminal to pay for the ticket in order to use the related function.

In some embodiments, the ticket may be removed from the user of the user terminal if the user performs an appropriate operation on the ticket. For example, the user may spend the points to pay for the ticket. The processing unit 308 may generate the ticket ID before the processing unit 308 adds a ticket on the user of the user terminal, and the processing unit 308 may update the corresponding database such as store the ticket ID in the ticket DB 326 and update the user DB accordingly or the like.

The processing unit 308 is configured to process the data of the violation and treatment on the user of the user terminal. In some embodiments, the user may perform an operation on the information of the violation by the user terminal such as clicking or tapping a button on the screen to send a signal of response to the server 10. For example, the user may click the OK button to accept the treatment or punishment, click the appeal button to report the error of violation, click the probation button to apply for probation or the like. The user terminal may send the signal of the data to the server 10 and the processing unit 308 may process the data for the user terminal of the user. More specifically, the processing unit 308 may receive the data, update the corresponding database, change the status of the user or the like.

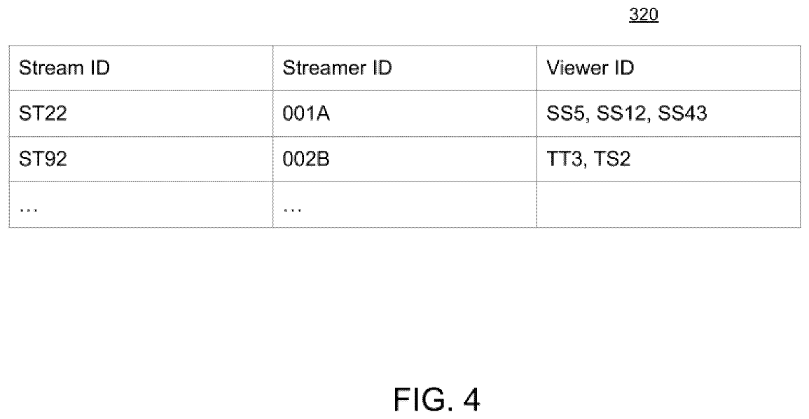

FIG. 4 shows an exemplary data structure of the stream DB 320 of FIG. 3. The stream DB 320 holds information regarding a live stream currently taking place. The stream DB 320 stores a stream ID for identifying a live-stream on a live distribution platform provided by the live-streaming system 1, a streamer ID for identifying the streamer who provides the live-stream, and a viewer ID for identifying a viewer of the live-stream, in association with each other.

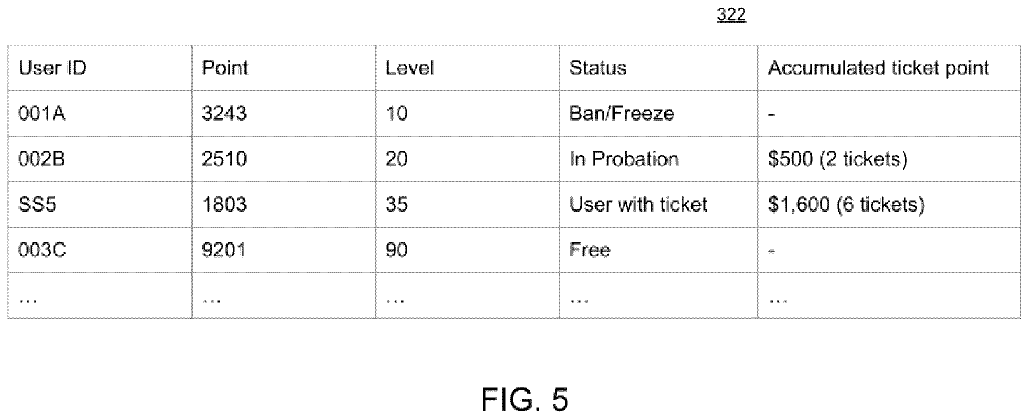

FIG. 5 shows an exemplary data structure of the user DB 322 of FIG. 3. The user DB 322 holds information regarding users. The user DB 322 stores a user ID for identifying a user, points for identifying the points the user has, in association with each other. The point is the electronic value circulated within the live-streaming platform. In some embodiments, some actions performed by the users may require the user to consume a certain amount of points or coins. The points or coins may be purchased by the user in the APP or platform. The points may be used for purchasing virtual items, subscribing to a membership, applying for specific functions, changing status, removing the received ticket or the like in the live-streaming platform. For example, the virtual items may be the gifts to the streamer, membership, status or the like.

In some embodiments, the user DB 322 may store the level of the user. The level is an indicator of the amount of user activity on the live-streaming platform. The level of the user is raised by interaction such as giving gifts as a viewer, performing live-streams as a streamer, participating in events, and the like. The server 10 calculates the level of the user from the history of the user's activity.

In some embodiments, the user DB 322 may store the status of the user. The status is the user's current status in the platform. The default status of each user may be “free” when the user joins the platform. The status of the user may be changed according to the operations the user performs on the platform. The processing unit 308 may update the status of each user in response to the operation the user performs.

In some embodiments, the user DB 322 may store the accumulated ticket point of the tickets the user has. The accumulated ticket point may be the accumulated ticket point the user received. In some embodiments, the accumulated ticket point may further include the number of tickets the user received for reference. The processing unit 308 may update the accumulated ticket point of each user in response to the operation the user performs.

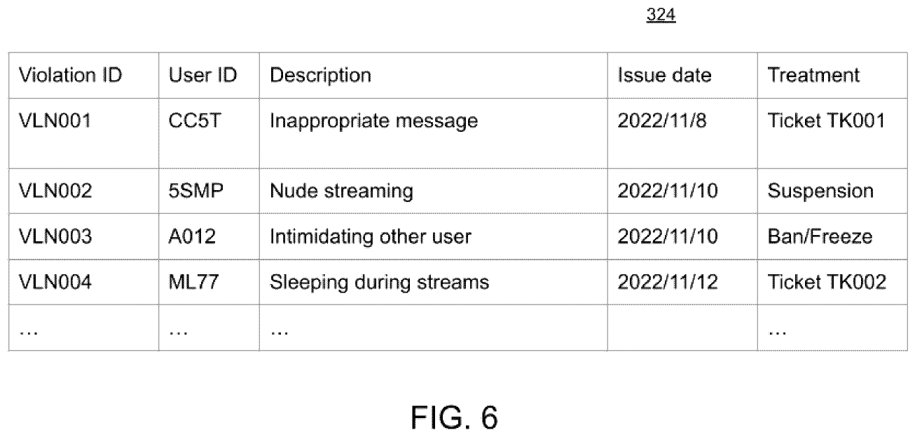

FIG. 6 shows an exemplary data structure of the violation DB 324 of FIG. 3. The violation DB 324 holds information regarding violations the monitoring unit 306 detected. The violation DB 324 stores a violation ID for identifying a violation on a live distribution platform provided by the live-streaming system 1, a user ID for identifying the user who violates the rules, a description for the description of the violation, an issue date for identifying the issue date of the violation, and a treatment for identifying the treatment to the violation, in association with each other.

In some embodiments, the monitoring unit 306 and the processing unit 308 may maintain and update the violation DB 324. The monitoring unit 306 may update the violation DB 324 once a violation is detected. The monitoring unit 306 may look up the violation look-up table (later described in detail) to identify the violation and its corresponding treatment. In some embodiments, the treatment may include detailed information such as the ticket point, ticket duration, ban/freeze duration or the like. The monitoring unit 306 may monitor the operation the user performs and detect violations according to the violation look-up table 330 to identify the violation. The monitoring unit 306 may further transmit the information of violation to the user of the user terminal and update the user DB 322, violation DB 324 or the like.

In some embodiments, the issue date may be used to calculate the due date according to the duration of the treatment such as ticket, probation or the like. The monitoring procedure may be realized manually or automatically. In some embodiments, the server 10 may automatically detect violations of the user by monitoring interactions between the user and other users in the live streaming platform. In some embodiments, the server 10 may determine whether the monitored interactions satisfy a predetermined violation condition. In some embodiments, the violation may be detected by the server 10 or may be reported by the other user. The server 10 may take corresponding actions when violations are detected or received from the other users. In some embodiments, machine learning technology may be introduced to realize automatic monitoring, detecting or the like.

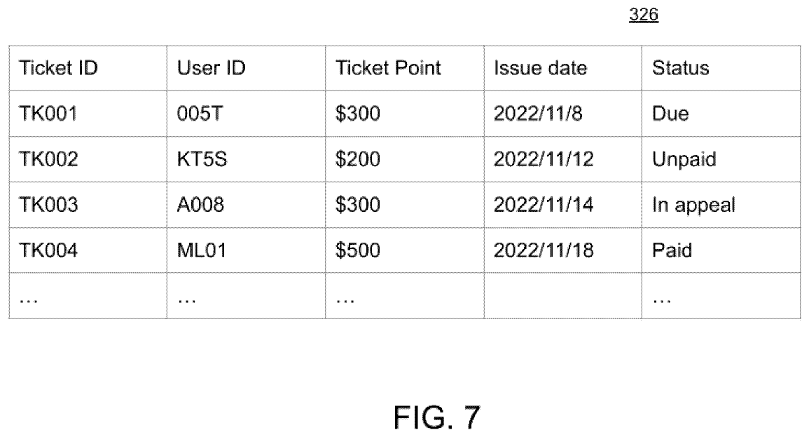

FIG. 7 shows an exemplary data structure of the ticket DB 326 of FIG. 3. The ticket DB 326 holds information regarding tickets the processing unit 308 generates and transmits to the user. The ticket DB 326 stores a ticket ID for identifying a ticket on a live distribution platform provided by the live-streaming system 1, a user ID for identifying the user who received the ticket, a ticket point for identifying the point of the ticket, an issue date for identifying the issue date of the ticket, and a status for identifying the current status of the ticket, in association with each other.

Each ticket may have a ticket point, and the users may use their points to pay for the ticket. The ticket may be canceled or removed if the user pays for the equivalent ticket points. In some embodiments, the issue date may be used to calculate the due date according to the duration of the ticket. In some embodiments, the duration for each ticket may be the same or different according to the practical need. Each ticket may have a due date, and the users are required to pay the ticket by the due date. If the user does not pay the ticket by the due date, the user will violate the rules and get banned or frozen or the like.

In some embodiments, if the status of the tickets reaches a threshold such as five tickets, then the user violates the rules and may be banned, frozen or the like. In some embodiments, the rule of the ticket may be determined flexibly. In some embodiments, the status of the tickets may include paid, unpaid, due, in appeal or the like. In some embodiments, the ticket point, due date and the status for each ticket may be determined according to the practical need.

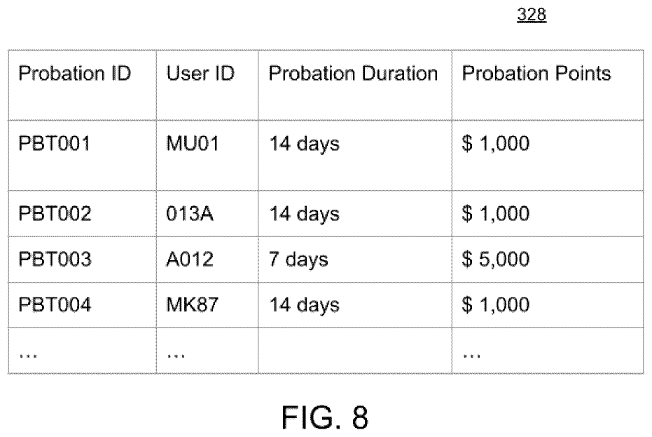

FIG. 8 shows an exemplary data structure of the probation DB 328 of FIG. 3. The probation DB 328 holds information regarding probations the user applied for. The probation DB 328 stores a probation ID for identifying a probation the user applied for on a live distribution platform provided by the live-streaming system 1, a user ID for identifying the user who applied for the probation, a duration for identifying the duration of the probation, and a probation point for identifying the point of the probation, in association with each other.

Each probation may have a probation duration and/or probation points, the user may pay the probation point to receive corresponding probation duration. In some embodiments, the probation duration may be the same as the duration of being banned or frozen. In other words, if the user violates the rule and would be banned or frozen for 14 days, the probation duration may also be 14 days. In some embodiments, server 10 may provide one probation package or more than one probation package for the user of the user terminal. In some embodiments, the user may spend a specific amount of points in exchange for the probation package. The probation duration and probation points may be determined according to the practical need.

In some embodiments, the point may be inversely proportional to the duration. In other words, the shorter the duration is and the higher the point would be. According to the embodiments, the probation function may be applied by the user of the user terminal so the user may continue using the live streaming system 1. Therefore, the user experience may be improved. Moreover, it may ensure that the user would not violate the rules again during probation period, and the quality of the live streaming system 1 may also be improved.

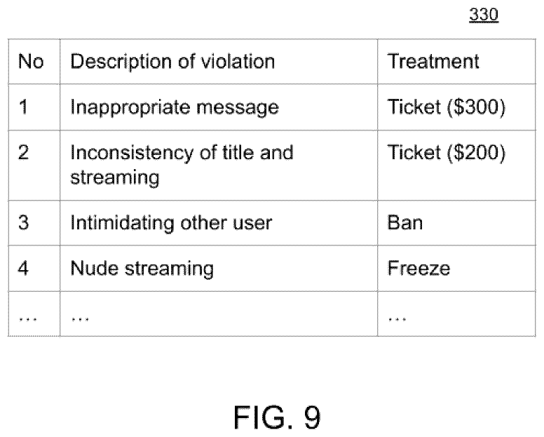

In some embodiments, the server 10 may include a violation look-up table 330 as shown in FIG. 3. The violation look-up table 330 may be configured to store the description of violations and the corresponding treatments in the platform. FIG. 9 shows an exemplary data structure of the violation look-up table 330 of FIG. 3. The violation look-up table 330 holds the description of the violation and the corresponding treatment. The violation look-up table 330 stores a description for identifying a violation in the platform, and a corresponding treatment for identifying the treatment if a user violates the rule in the platform.

The description of the violation and the corresponding treatment may be determined by server 10 or the like. In some embodiments, the violation look-up table 330 may be predetermined flexibly according to practical need. In some embodiments, the violation look-up table 330 may be updated dynamically in real time. The violation look-up table 330 may also be modified or updated by machine learning technology. The machine learning model may be introduced to predict the violation and recommend the corresponding treatment or the like. In some embodiments, the violation look-up table 330 may be determined flexibly.

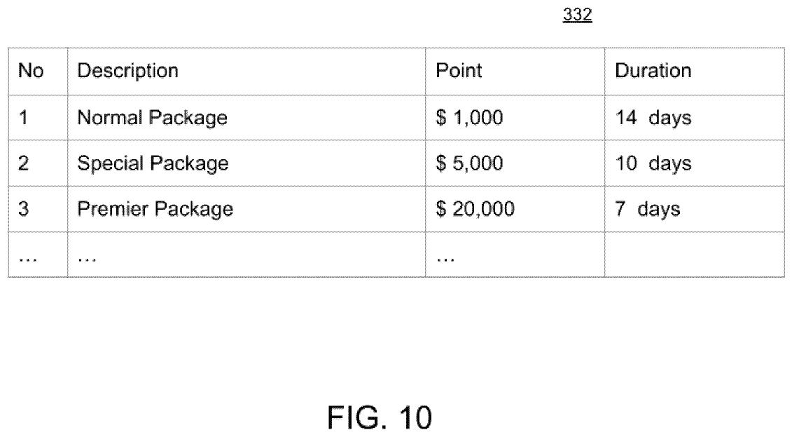

In some embodiments, the server 10 may include a probation look-up table 332 as shown in FIG. 3. The probation look-up table 332 may be configured to store the available probation package and the corresponding probation point and probation duration in the platform. FIG. 10 shows an exemplary data structure of the probation look-up table 332 of FIG. 3. The probation look-up table 332 holds a description of the probation package and the corresponding probation point and probation duration. The probation look-up table 332 stores a description for identifying a probation package in the platform, and a corresponding point and duration for identifying the point and duration if a user would like to apply for the probation package in the platform.

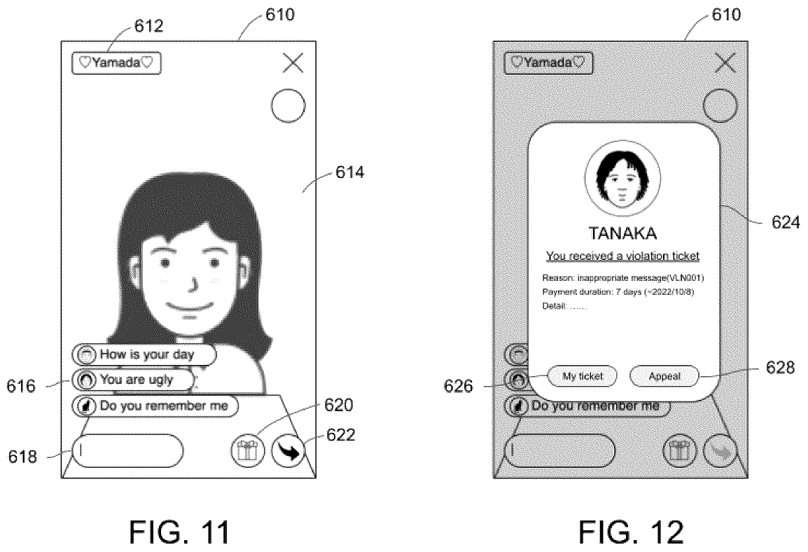

FIG. 11-FIG. 19 are exemplary screen images of a live-streaming room screen 610 shown on the display of the streamer user terminal 20 or the viewer user terminal 30.

FIG. 11 is an exemplary screen image of a live-streaming room screen 610 shown on the display of the viewer user terminal 30. Once the viewer selects and enters a live-streaming room, the live-streaming room screen 610 of the streamer may be shown on the display. The live-streaming room screen 610 may include a streamer info object 612, streamer image 614, message zone 616, message input box 618, gifting object 620, sharing object 622 or the like. The streamer info object 612 may include information of the streamer. In some embodiments, the streamer info object 612 may include a button for the viewer to follow the streamer or the like. The streamer image 614 may be obtained by reproducing the video data. The message zone 616 may include the interaction message in the streaming room such as messages from the user, gifting information, server notification or the like. The message input box 618 may allow the user to enter a message and send it to the live streaming room. The gift object 620 may be the object for the viewer to tap in order to send a gift to the streamer. The sharing object 622 may be the object for the viewer to tap in order to share the live streaming room with other users.

In some embodiments, a viewer may tap on the message input box 618 in the viewer user terminal 30 to send a message to the streamer. For example, the viewer may send a message of “how is your day” to interact with the streamer. In the live streaming system 1, the monitoring unit 306 may monitor the action or behavior of the user to check if any violations occur. In some embodiments, insulting words are always considered as a violation in a platform. If a viewer sends a message of “you are ugly” in the streaming room, the monitoring unit 306 may detect the violation from the user of the user terminal.

FIG. 12 is an exemplary screen image of a live-streaming room screen 610 shown on the display of the viewer user terminal 30. As shown in FIG. 12, the viewer may receive the information 624 on the viewer user terminal. The information 624 may include the user information of the user who violates the rules, the title of the violation, the reason for the violation, the detailed information related to the violation or the like. In some embodiments, the information 624 may include time information. For example, if the user receives a ticket, the information 624 may include the due date for paying the ticket.

As shown in FIG. 12, the reason for the violation may be “inappropriate message” and the violation ID may also be attached for reference. The payment duration may be “7 days” and the due date may also be attached for reference. The detail may be the information to the user for reference. For example, the details may be “Please pay the ticket before the due date. If the ticket is due or unpaid tickets are over 5, the account will be banned or frozen. If appeal is necessary, please contact the customer support.” or the like. In some embodiments, the information may be designed and determined according to the practical need.

The information 624 may also include information for the user to respond to the information 624. For example, the information 624 may include a my-ticket button 626 and appeal button 628. The my-ticket button 626 may access the user to the ticket page the user currently has. The appeal button 628 may access the user to the appeal page if the user would like to report the error of the violation.

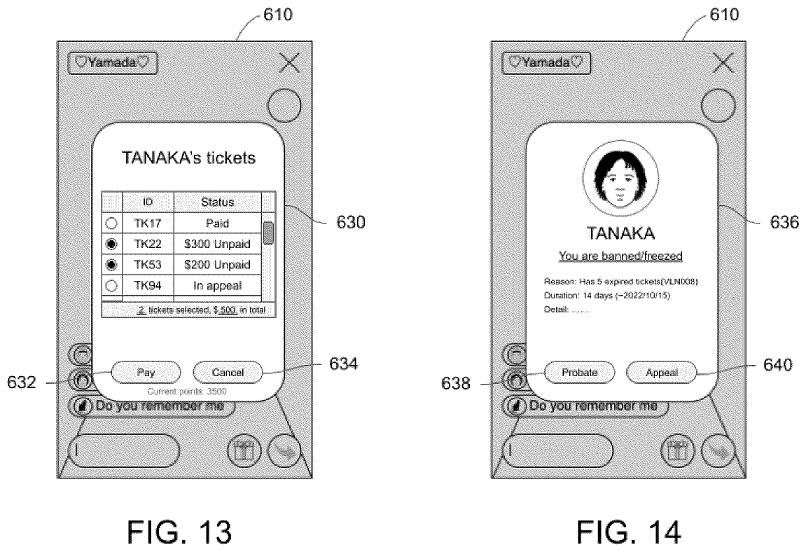

As shown in FIG. 13, the user may be directed to the ticket page 630 if the user taps the my-ticket button 626 on the user terminal. The ticket page 630 may include the information of the ticket the user currently has, such as the ticket ID and the status of the tickets. The status of the tickets may be the points of the ticket and the payment status of the tickets such as paid, unpaid, due soon, overdue, in appeal or the like. The ticket page 630 may include a pay button 632 and cancel button 634. The user may select the ticket and tap on the pay button 632 to launch a payment procedure. In some embodiments, the ticket page 630 may include other information such as the current points the user has, the number of selected tickets and the payment in total or the like for the user's reference.

In some embodiments, if the user violates a serious rule, the server 10 may ban or freeze the user. As shown in FIG. 14, the viewer may receive the information 636 and the information 636 may include information on being banned or frozen. The information 636 may include the user information, the reason for being banned or frozen, the duration, the detailed information or the like. The information 636 may include punishment duration such as ban/freeze duration or probation period or the like. As shown in FIG. 14, the reason for the violation may be “Has 5 expired tickets” and the violation ID may also be attached for reference. The duration may be “14 days” and the due date may also be attached for reference. The detail may be the information to the user for reference. For example, the details may be “You may not be able to get access to the platform for 14 days. You may pay the probation point to be in probation and all the functions are normal during the probation. If appeal is necessary, please contact the customer support.” or the like. In some embodiments, the information may be designed and determined according to the practical need.

In some embodiments, the information 636 may further include possible responses the user may make. For example, the information 636 may include a probation button 638 and appeal button 640. The probation button 638 may access the user to the probation function page. The appeal button 640 may access the user to the appeal page if the user would like to report the error of the violation. According to the embodiments, the user who is going to be banned or frozen may have more alternatives to respond to the banning or freezing information, and the user experience may be improved.

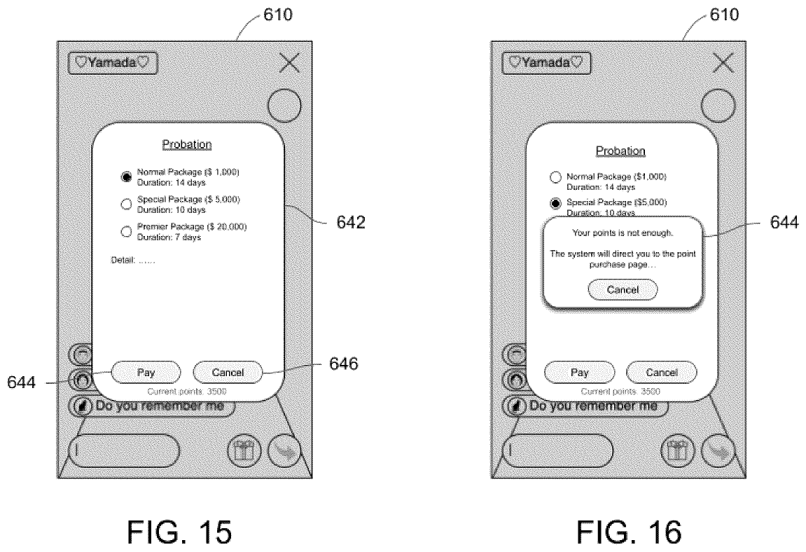

As shown in FIG. 15, the user may be directed to the probation function page 642 if the user taps the probation button 638 on the user terminal. The probation function page 642 may include the information of the probation function, such as available probation package and its corresponding points and durations. The probation function page 642 may also include any related information such as the details of the probation function. As shown in FIG. 15, the detail may be the information to the user for reference. For example, the details may be “All the functions are normal during the probation. The probation point will be kept from being used during the probation. If the user violates the rule during probation, the probation point will be confiscated. Otherwise, the probation point will be returned after the probation.” or the like. In some embodiments, the information may be designed and determined according to the practical need.

The probation function page 642 may include a pay button 644 and cancel button 646. The user may select the package and tap on the pay button 644 to launch a payment procedure. In some embodiments, the probation function page 642 may include other information such as the current points the user has, the confirmation information of the selected package and the payment in total or the like for the user's reference.

In some embodiments, if the user does not have enough points to finish the payment, the user may be accessed to an in-app purchase page or a third-party page to purchase points. As shown in FIG. 16, if the user would like to purchase the $5,000 points package but the current points the user has is only $3,500 points, the server 10 may direct the user to the point purchase page. The server 10 may transmit information 644 to notify the user that the user will be directed to the point purchase page. The design of the point purchase page may be determined flexibly and would not be described in detail here.

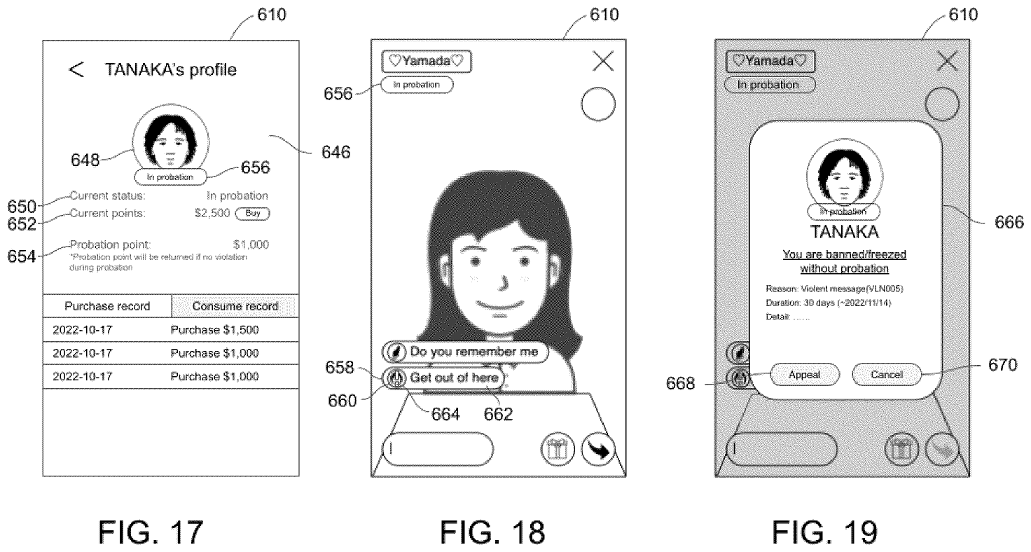

If the user finishes the payment and applied for the probation function successfully, the user will not be banned or frozen by the server 10 during the probation duration. In some embodiments, the payment may be kept as a probation point for the user. The probation point will be returned if the user does not violate any rules during the probation period. As shown in FIG. 17, the user may check the personal information in the profile page 646. The profile page 646 may include the image object 648, the status information 650, the points information 652, the probation point information 654 or the like. The status information 650 shows the current status of the user, such as “free”, “user with ticket”, “in probation” or the like. The points information 652 shows the points the user has. The probation points information 654 shows whether there is any probation point and how much the probation point is or the like. In some embodiments, the profile page 646 may also include the record of purchasing and consuming the points for the user's reference.

In some embodiments, if the user is with certain status such as “user with ticket” or “in probation” or the like, the server 10 may display an object on the user terminal. For example, a status object 656 may be shown under the image object 648 of the user terminal in the profile page 646. In some embodiments, the status object 656 may also be shown in the live streaming room as shown in FIG. 18. According to the embodiments, the user may understand his or her current status when watching a live stream. In some embodiments, the status object 656 may only be seen by the user of the user terminal only.

In some embodiments, the server 10 may display an object on a user of a user terminal to indicate the status of the user of the user terminal. For example, the message 658 sent by the user may include the user icon 660 and the contents 662 of the message. If the status of the user is in probation, an object 664 may be added to the user icon 660 in the message 658 to indicate that the user is currently in probation status.

In some embodiments, the status object 656 may only be seen by the user. In some embodiments, the object 664 may be seen by the streamer and other viewers in the streaming room. According to the embodiments, the streamer and viewers may understand that the status of the user is in probation. The streamer and other viewers may know that the user violated the rule so they may be careful on the user. If the user has unpaid tickets and another object may also be added to the user to indicate that the user has unpaid tickets. In this situation, the streamer and other viewers may also notice and/or help the user with paying the tickets or the like. In some embodiments, the streamer or the other user may report the violation of the user in probation, and the server 10 may reward the reporter with extra points or the like. In some embodiments, the object 664 may be on the whole message 658, on the user icon 660, on the message 658 or the like. The object 664 may be an exclamation mark, green eye, special icon, color, frame, shadow or the like. In some embodiments, the object may be changed according to the status of the user. In some embodiments, the object 664 may be designed flexibly.

In some embodiments, the status of the user may be changed from “in probation” to “free” if the user does not violate the rule during the probation period. However, the status of the user may be changed back to ban/freeze if the user violates the rule during the probation period. As shown in FIG. 18, if the user sends the message 658 of “get out of here” in the streaming room, the monitoring unit 306 may detect the violation and transmit the information of the violation to the user. Since the status of the user is “in probation”, the probation function may not be available for the user.

In some embodiments, the user may violate the rule during the probation period. As shown in FIG. 19, the viewer may receive information 666 related to the information of being banned or frozen. Since the violation is detected during the probation period, the information 666 may not include the information of the probation function. The information 666 may include the user information, the reason for being banned or frozen, the duration, the detailed information or the like. As shown in FIG. 19, the reason for the violation may be “Violent message” and the violation ID may also be attached for reference. The duration of the punishment may be “30 days” and the end date may also be attached for reference. The detail may be the information to the user for reference. For example, the details may be “You may not be able to get access to the platform for 30 days. No probation is applicable. If appeal is necessary, please contact the customer support.” or the like. In some embodiments, the information may be designed and determined according to the practical need. According to the embodiments, it may motivate the user of the user terminal to pay more attention to the rules in the platform, and the user experience may be improved.

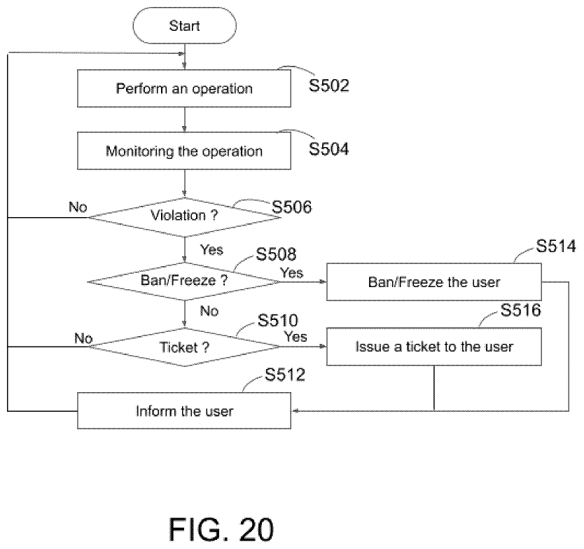

FIG. 20 is an exemplary flowchart illustrating an operation of the configuration of the live streaming system 1 according to some embodiments of subject application. In some embodiments, the user may perform an operation on the platform (S502). The operation may include any possible operation the user may perform on the platform, such as broadcasting, watching, commenting, posting or the like. The server 10, more specifically the monitoring unit 306, may monitor the operation the user performed on the platform (S504). If the server 10 does not detect any violation from the user (NO in S506), the user may keep performing operations and the server may keep monitoring the operations from the user (S502 and S504).

If the server 10 detects any violation from the user (YES in S506), the server 10 may check the violation and the corresponding treatment. If the treatment is to ban or freeze the user (YES in S508), the server 10, more specifically the processing unit 308, may process the procedure of banning or freezing the user (S514). The procedure may include any related procedure for banning or freezing the user such as generating a violation ID, updating the corresponding database or the like. The server 10 may further inform the user of the information of the violation and treatment (S512) so that the user may respond to the information in an appropriate manner. In some embodiments, the procedure may end or be iterated from S502 again to start another monitoring and detection.

If the treatment is not to ban or freeze the user (NO in S508), the server 10 may check if the treatment is to transmit a ticket to the user of the user terminal (S510). If the treatment is not to transmit a ticket to the user (NO in S510), the user may keep performing operations and the server may keep monitoring the operations from the user (S502 and S504). If the treatment is to transmit a ticket to the user (YES in S510), the server 10 may process the procedure of issuing a ticket to the user (S516). The procedure may include any related procedure for issuing a ticket to the user such as generating a ticket ID, updating the corresponding database or the like. The server 10 may further inform the user of the information of violation and treatment (S512) so that the user may respond to the information in an appropriate manner.

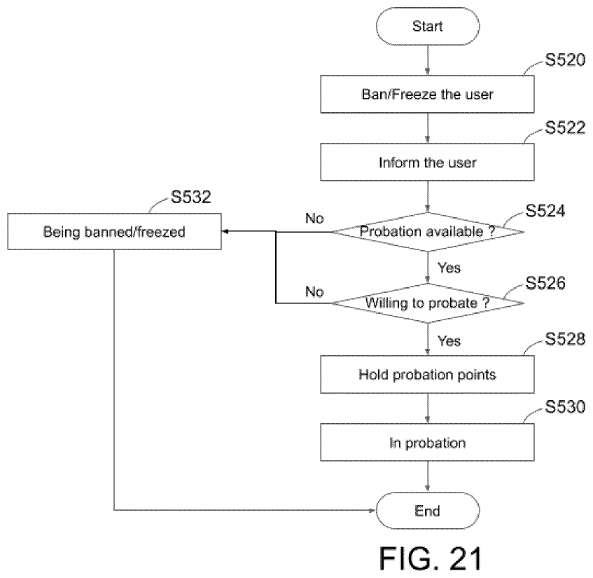

FIG. 21 is an exemplary flowchart chart illustrating an operation of the configuration of the live streaming system 1 according to some embodiments of subject application. In some embodiments, the processing unit 308 may process the procedure of banning or freezing the user of the user terminal (S520). The server 10 may further inform the user of the information of the violation and the corresponding treatment (S522) so that the user may respond to the information in an appropriate manner. In some embodiments, the processing unit 308 may ban or freeze the user due to the violation. In some embodiments, the processing unit 308 may provide the user of the user terminal with available alternatives. For example, the processing unit 308 may provide the user with the probation function if the user is not in a probation status. If the probation is not available (NO in S524), the processing unit 308 may process the procedure of banning or freezing, and the user of the user terminal may be banned or frozen (S532).

In some embodiments, the probation function may be available according to the status of the user. For example, if the user is not in the status of probation, the probation function may be available to the user. In some embodiments, the probation function may be available according to the attribute of the violation. For example, the server 10 may provide the user with the probation function if the severity of the violation is relatively low or the like. In some embodiments, the probation function may be provided for specific violations and the violations may be determined flexibly by the APP or platform provider. In some embodiments, server 10 may also record the violation history of the user and provide a probation function according to the violation record of the user. If the user violates the same rules or violation rules during probation, the server 10 may not provide the user with the probation function. In some embodiments, the availability of the probation function may be determined flexibly according to the practical need.

If the probation function is available to the user of the user terminal (YES in S524), the processing unit 308 may further provide the information of the probation function to the user. The user may determine whether to apply for the probation function or not. If the user is not willing to apply for the probation function (NO in S526), the processing unit 308 may process the procedure of banning or freezing, and the user of the user terminal may be banned or frozen (S532). If the user is willing to apply for the probation function (YES in S526), the user may perform an operation to apply for the probation function. In some embodiments, the user may spend a specific amount of points in exchange for the probation function. In response to the operation from the user, the processing unit 308 may hold the probation points for the user of the user terminal (S528) and set the status of the user as in probation (S530).

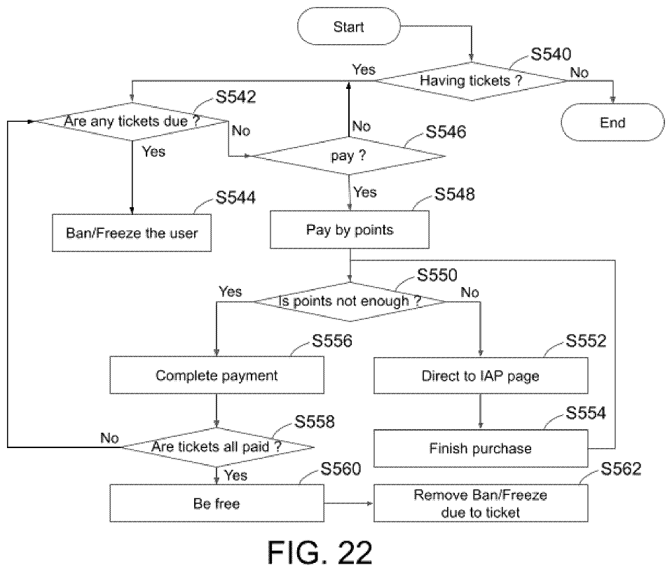

FIG. 22 is an exemplary flowchart chart illustrating an operation of the configuration of the live streaming system 1 according to some embodiments of subject application. In some embodiments, the user may receive tickets due to violation. Server 10 may periodically monitor and update the corresponding database. For example, server 10 may record the number of tickets each user has in the corresponding database. If the user has no tickets (NO in S540), the server 10 may do nothing to the user. If the user has tickets (YES in S540), the server 10, more specifically the processing unit 308, may monitor the status of the tickets. In some embodiments, the processing unit 308 may check whether there are any tickets due or not (S542).

If there are any tickets due (YES in S542), the processing unit 308 may process the procedure of banning or freezing the user as a punishment. If there is no ticket due (NO in S542), the processing unit 308 may keep monitoring the due date of the ticket the user received. In some embodiments, the processing unit 308 may inform or remind the user of the status of the tickets. The user may determine whether to pay the ticket or not (S546). If the user does not pay the ticket (NO in S546), the processing unit 308 may keep monitoring the status of the tickets. If the user would like to pay the ticket (YES in S546), the user may pay the tickets by the points the user has (S548).

The processing unit 308 may check if the points the user has is enough to pay the tickets or not (S550). If the points the user has is not enough to pay the tickets (NO in S550), the processing unit 308 may direct the user to the point-purchase page (S552). In some embodiments, the point-purchase page may be an IAP (in-app purchase) page or the third-party service or the like. The user may finish the purchase by any possible payment method (S554). In some embodiments, the payment method may be a third-party service or service provided by the platform or the like. After the purchase is finished, the processing unit 308 may direct the user back to the ticket payment page and check if the points the user has is enough to pay the tickets or not (S550).

If the points the user has is enough to pay the tickets (YES in S550), the server 10 may process and complete the payment (S556). The processing unit 308 may further check whether all tickets are paid or not (S558). If there are any unpaid tickets (NO in S558), the processing unit 308 may check whether there are any tickets due or not (S542). If all the tickets are paid (YES in S558), the processing unit 308 may set the status of the user of the user terminal as free. In some embodiments, the status of being free may be referred to as the status without any punishment due to violation such as ticket, ban, freeze or the like. In some embodiments, the user may be banned or frozen due to the status of the tickets. For example, the user may be banned or frozen because the number of tickets exceeds a certain value, or there are any overdue tickets or the like. In some embodiments, the processing unit 308 may remove the status of being banned or frozen from the user if the user finishes the payment of the tickets (S562).

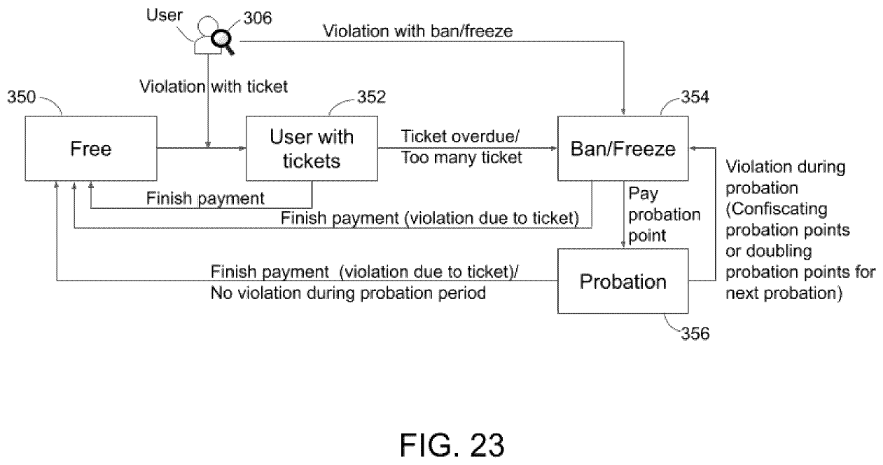

FIG. 23 is a schematic block diagram of the status mechanism in the live streaming system 1 according to some embodiments of subject application. As shown in FIG. 23, the status of the user in the live streaming system 1 may include status of free 350, user with tickets 352, ban/freeze 354 and probation 356. The user may interact with each other via the server 10 in the live streaming system 1. In some embodiments, the status of the user may be free if the user does not receive any punishment or treatment. In some embodiments, the status of free 350 may be referred to as the first status, the status of ban/freeze 354 may be referred to as the second status, the status of probation 356 may be referred to as the third status, and the status of user with tickets 352 may be referred to as the fourth status. The monitoring unit 306 may monitor the actions the user performs and the interaction among users and users. In some embodiments, the users may violate the rule in the platform. The treatment to the violation may be determined according to the degree of violation. In some embodiments, the treatment may be to add a ticket on the user, and the processing unit 308 may set the status of the user to user with ticket 352. In some embodiments, the treatment may be to ban or freeze the user, and the processing unit 308 may set the status of the user to ban/freeze 354. In some embodiments, the status of the tickets may affect the status of the user of the user terminal. The processing unit 308 may set the status of the user from user with tickets 352 to ban/freeze 354. For example, the status of the user may be set to ban/freeze 354 if the user has overdue tickets or has too many tickets or the like. In some embodiments, the processing unit 308 may set the status of the user from free 350 to ban/freeze 354 directly if the user violation serious rules in the APP or platform.

In some embodiments, the status of the user may be changed from user with tickets 352 to free 350 if the user finishes payment of the tickets. In some embodiments, the status of ban/freeze 354 of the user may be due to the ticket the user has. In this situation, the status of the user may be changed from ban/freeze 354 to free 350 if the user finishes payment of the tickets. In some embodiments, the status of ban/freeze 354 of the user may be due to other reasons than tickets. In this situation, the user may pay the probation point in exchange for the probation function. The processing unit 308 may set the status of the user from ban/freeze 354 to probation 356 if the user pays the probation point. In some embodiments, the user with the status of probation 356 may have the same or similar functionality to the user with the status of free 350. In some embodiments, the processing unit 308 may set the status of the user from probation 356 back to ban/freeze 354 if the user violates the rule during probation. In some embodiments, the status of ban/freeze 354 due to tickets may be applied for probation function. In this situation, the status of the user may be changed from probation 356 to free 350 if the user finishes payment of the tickets. In some embodiments, the processing unit 308 may set the status of the user from probation 356 to free 350 if the user does not violate the rule during probation. In some embodiments, the status mechanism in the live streaming system 1 may be designed flexibly according to the practical need.

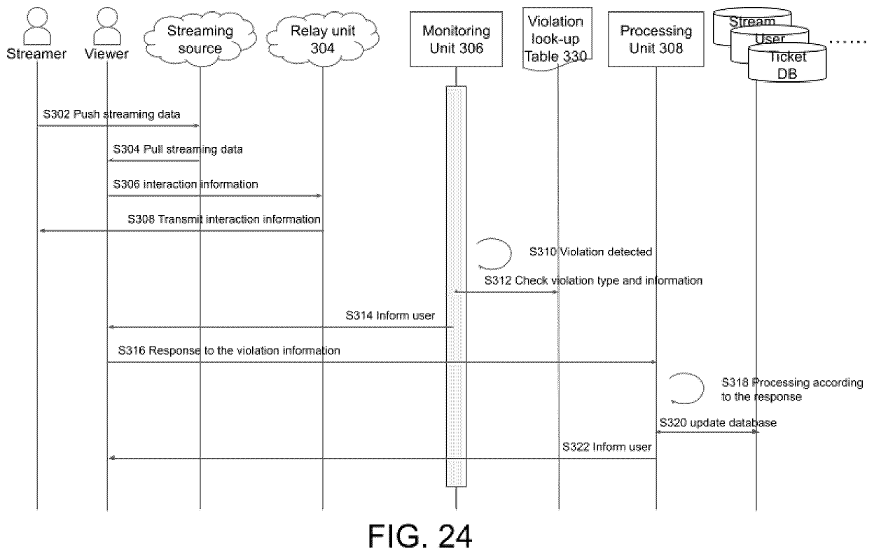

FIG. 24 is an exemplary sequence chart illustrating an operation of the configuration of the live streaming system 1 according to some embodiments of subject application.

In some embodiments, a streamer may start a live streaming by pushing the streaming data to a streaming source (S302). Viewers may pull the streaming data by tapping on the streamer the viewer would like to watch (S304). During the live streaming, the viewers may interact with the streamer by sending interaction information such as comments, gifts, animations or the like (S306). The server 10, more specifically the relay unit 403, may receive and transmit the interaction information to the streamer and other viewer in the live streaming room (S308). In some embodiments, the monitoring unit 306 may monitor the action or the interaction among users of user terminals. If the monitoring unit 306 detects violation from the users (S310), the monitoring unit 306 may look up the violation look-up table 330 to identify the violation and its corresponding treatment (S312).

The monitoring unit 306 may further inform the user of the violation and treatment (S314). The user may receive the violation and treatment by the user terminal, and the user may further respond to the violation information. The processing unit 308 may process the corresponding procedure according to the response from the user terminal (S318). In addition, the processing unit 308 may also update the corresponding database such as stream DB, user DB, ticket DB or the like (S320). After the procedure, the processing unit 308 may inform the user of the information, such as the status or the user or the like (S322). According to the embodiments, the user experience may be improved.

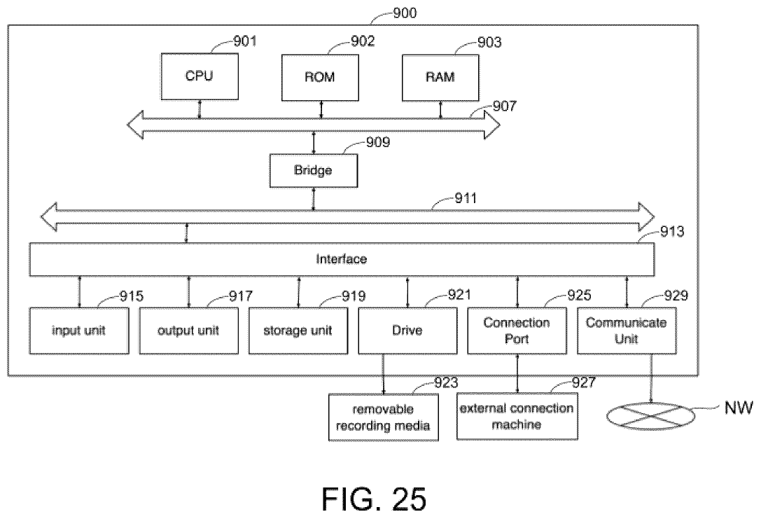

FIG. 25 is a schematic block diagram of computer hardware for carrying out a system configuration and processing according to some embodiments of subject application. The information processing device 900 in FIG. 25 is, for example, is configured to realize the server 10 and the user terminal 20, 30 respectively according to some embodiments of subject application.

The information processing device 900 includes a CPU 901, read only memory (ROM) 903, and random-access memory (RAM) 905. In addition, the information processing device 900 may include a host bus 907, a bridge 909, an external bus 911, an interface 913, an input unit 915, an output unit 917, a storage unit 919, a drive 921, a connection port 925, and a communication unit 929. The information processing device 900 may include imaging devices (not shown) such as cameras or the like. The information processing device 900 may include a processing circuit such as a digital signal processor (DSP) or an application-specific integrated circuit (ASIC), instead of or in addition to the CPU 901.

The CPU 901 functions as an arithmetic processing device and a control device, and controls the overall operation or a part of the operation of the information processing device 900 according to various programs recorded in the ROM 903, the RAM 905, the storage unit 919, or a removable recording medium 923. For example, the CPU 901 controls overall operations of respective function units included in the server 10 and the user terminal 20 and 30 of the above-described embodiment. The ROM 903 stores programs, operation parameters, and the like used by the CPU 901. The RAM 905 transiently stores programs used when the CPU 901 is executed, and parameters that change as appropriate when executing such programs. The CPU 901, the ROM 903, and the RAM 905 are connected with each other via the host bus 907 configured from an internal bus such as a CPU bus or the like. The host bus 907 is connected to the external bus 911 such as a Peripheral Component Interconnect/Interface (PCI) bus via the bridge 909.

The input unit 915 is a device operated by a user such as a mouse, a keyboard, a touchscreen, a button, a switch, and a lever. The input unit 915 may be a device that converts physical quantity to electrical signal such as audio sensor (such as microphone or the like), acceleration sensor, tilt sensor, infrared radiation sensor, depth sensor, temperature sensor, humidity sensor or the like. The input unit 915 may be a remote-control device that uses, for example, infrared radiation and another type of radio waves. Alternatively, the input unit 915 may be an external connection device 927 such as a mobile phone that corresponds to an operation of the information processing device 900. The input unit 915 includes an input control circuit that generates input signals on the basis of information which is input by a user to output the generated input signals to the CPU 901. The user inputs various types of data and indicates a processing operation to the information processing device 900 by operating the input unit 915.

The output unit 917 includes a device that can visually or audibly report acquired information to a user. The output unit 917 may be, for example, a display device such as an LCD, a PDP, and an OLED, an audio output device such as a speaker and a headphone, and a printer. The output unit 917 outputs a result obtained through a process performed by the information processing device 900, in the form of text or video such as an image, or sounds such as audio sounds.

The storage unit 919 is a device for data storage that is an example of a storage unit of the information processing device 900. The storage unit 919 includes, for example, a magnetic storage device such as a hard disk drive (HDD), a semiconductor storage device, an optical storage device, or a magneto-optical storage device. The storage unit 919 stores therein the programs and various data executed by the CPU 901, and various data acquired from an outside.

The drive 921 is a reader/writer for the removable recording medium 923 such as a magnetic disk, an optical disc, a magneto-optical disk, and a semiconductor memory, and built in or externally attached to the information processing device 900. The drive 921 reads out information recorded on the mounted removable recording medium 923, and outputs the information to the RAM 905. The drive 921 writes the record into the mounted removable recording medium 923.

The connection port 925 is a port used to directly connect devices to the information processing device 900. The connection port 925 may be a Universal Serial Bus (USB) port, an IEEE1394 port, or a Small Computer System Interface (SCSI) port, for example. The connection port 925 may also be an RS-232C port, an optical audio terminal, a High-Definition Multimedia Interface (HDMI (registered trademark)) port, and so on. The connection of the external connection device 927 to the connection port 925 makes it possible to exchange various kinds of data between the information processing device 900 and the external connection device 927.

The communication unit 929 is a communication interface including, for example, a communication device for connection to a communication network NW. The communication unit 929 may be, for example, a wired or wireless local area network (LAN), Bluetooth (registered trademark), or a communication card for a wireless USB (WUSB).

The communication unit 929 may also be, for example, a router for optical communication, a router for asymmetric digital subscriber line (ADSL), or a modem for various types of communication. For example, the communication unit 929 transmits and receives signals on the Internet or transmits signals to and receives signals from another communication device by using a predetermined protocol such as TCP/IP. The communication network NW to which the communication unit 929 connects is a network established through wired or wireless connection. The communication network NW is, for example, the Internet, a home LAN, infrared communication, radio wave communication, or satellite communication.

The imaging device (not shown) is a device that images real space using an imaging device such as a charge coupled device (CCD) or a complementary metal oxide semiconductor (CMOS), for example, and various members such as a lens for controlling image formation of a subject image on the imaging device and generates a captured image. The imaging device may capture a still picture or may capture a movie.

The present disclosure of the live streaming system 1 has been described with reference to embodiments. The above-described embodiments have been described merely for illustrative purposes. Rather, it can be readily conceived by those skilled in the art that various modifications may be made in making various combinations of the above-described components or processes of the embodiments, which are also encompassed in the technical scope of the present disclosure.

The procedures described herein, particularly flowchart or those described with a flowchart, are susceptible of omission of part of the steps constituting the procedure, adding steps not explicitly included in the steps constituting the procedure, and/or reordering the steps. The procedure subjected to such omission, addition, or reordering is also included in the scope of the present disclosure unless diverged from the purport of the present disclosure.

In some embodiments, at least a part of the functions performed by the server 10 may be performed by other than the server 10, for example, being performed by the user terminal 20 or 30. In some embodiments, at least a part of the functions performed by the user terminal 20 or 30 may be performed by other than the user terminal 20 or 30, for example, being performed by the server 10. In some embodiments, the rendering of the frame image may be performed by the user terminal of the viewer, the server, the user terminal of the streamer or the like.

Furthermore, the system and method described in the above embodiments may be provided with a computer-readable non-transitory storage device such as a solid-state memory device, an optical disk storage device, or a magnetic disk storage device, or a computer program product or the like. Alternatively, the programs may be downloaded from a server via the Internet.

Although technical content and features of the present disclosure are described above, a person having common knowledge in the technical field of the present disclosure may still make many variations and modifications without disobeying the teaching and disclosure of the present disclosure. Therefore, the scope of the present disclosure is not limited to the embodiments that are already disclosed but includes another variation and modification that do not disobey the present disclosure, and is the scope covered by the following patent application scope.

### LIST OF REFERENCE NUMBERS

| | | | |
|---|---|---|---|
| 1 | Live streaming system | 10 | Server |
| 20 | User terminal | 100 | Streaming unit |
| 102 | Video control unit | 104 | Audio control unit |
| 106 | Distribution unit | 108 | UI control unit |
| 200 | Viewing unit | 202 | UI control unit |
| 204 | Rendering unit | 206 | Input transmit unit |
| 30, 30a, 30b | User terminal | 302 | Providing unit |
| 304 | Relay unit | 306 | monitoring unit |
| 308 | processing unit | 320 | Stream DB |
| 322 | User DB | 324 | Violation DB |
| 326 | Ticket DB | 328 | Probation DB |
| 330 | Violation look-up table | 332 | Probation look-up table |
| 610 | Screen | 612 | Streamer info object |
| 614 | Streamer image | 616 | Message zone |
| 900 | Information processing device | 901 | CPU |
| 903 | ROM | 905 | RAM |
| 907 | Host bus | 909 | Bridge |
| 911 | External bus | 913 | Interface |
| 915 | Input unit | 917 | Output unit |
| 919 | Storage unit | 921 | Drive |
| 923 | Removable recording medium | 925 | Connection port |
| 927 | External connection device | 929 | Communication unit |
| LS | Live streaming | LV | Streamer |
| NW | Network | SP | Specific portion |
| AU1, AU2 | Viewer | | |
| S502-S562, S302-S322 | Step | | |
| VD, VD1, VD2 | Video | | |

What is claimed is:

1. A server for handling violation in a live streaming platform, comprising one or a plurality of processors, wherein the one or plurality of processors execute a machine-readable instruction to perform:
transmitting a first information of a first violation of a first user to a first user terminal of the first user, wherein the first information includes information of setting the status of the first user terminal from first status to second status;
in response to a first operation on the first information from the first user terminal, setting the status of the first user terminal from first status to third status; wherein
the functions in the second status are more limited than the functions in the third status.

2. The server according to claim 1, further comprising:
checking availability of the third status to the first user of the first user terminal; wherein
the availability is determined according to the status of the first user, violation record of the first user, severity of the first violation or the like.

3. The server according to claim 1, further comprising:
transmitting a second information of a second violation of the first user to the first user terminal of the first user, wherein the second information includes information of setting the status of the first user terminal from third status to second status.

4. The server according to claim 1, wherein:
the first operation includes a decrease of a first point from the first user of the first user terminal.

5. The server according to claim 4, further comprising:
determining a first duration for the third status;
setting the status of the first user terminal from third status to first status after the first duration is over; and
returning the first point to the first user of the first user terminal.

6. The server according to claim 1, further comprising:
automatically detecting the first violation of the first user by monitoring interactions between the first user and other users in the live streaming platform and determining whether the monitored interactions satisfy a predetermined violation condition.

7. The server according to claim 1, wherein
the functions are functions related to interactions between the first user and other users in the live streaming platform.

8. A server for handling violation in a live streaming platform, comprising one or a plurality of processors, wherein the one or plurality of processors execute a machine-readable instruction to perform:
transmitting a first information of a first violation of a first user to a first user terminal of the first user, wherein the first information includes information of adding a first ticket on the first user of the first user terminal;
monitoring a status of the ticket of the first user; and
setting the status of the first user terminal to second status if the status of the ticket reaches a threshold.

9. The server according to claim 8, wherein:
the status of the ticket is at least one of the following: number of tickets, accumulated ticket points of the tickets, expiration date of the ticket or the like.

10. The server according to claim 8, wherein:
in response to a first operation on the ticket from the first user terminal, removing the first ticket from the first user of the first user terminal.

11. The server according to claim 8, wherein:
transmitting a second information of a second violation of the first user to the first user terminal of the first user; wherein the second information includes information of adding a second ticket on the first user of the first user terminal;
the first ticket limits a first function and the second tickets limits a second function; and
the first function is the same as or different from the second function.

12. The server according to claim 8, further comprising:
automatically detecting the first violation of the first user by monitoring interactions between the first user and other users in the live streaming platform and determining whether the monitored interactions satisfy a predetermined violation condition.

13. The server according to claim 8, wherein
the ticket is a ticket related to interactions between the first user and other users in the live streaming platform.

14. A method for handling violation in a live streaming platform, comprising:
transmitting a first information of a first violation of a first user to a first user terminal of the first user, wherein the first information includes information of setting the status of the first user terminal from first status to second status;
in response to a first operation on the first information from the first user terminal, setting the status of the first user terminal from first status to third status; wherein
the functions in the second status are more limited than the functions in the third status.
